(19) United States
(12) Patent Application Publication
(10) Pub. No.: US 2019/0250877 A1
(43) Pub. Date: Aug. 15, 2019

(54) LetzRock An app designed to eliminate manually skipping of the songs

(71) Applicant: Sriram Varadhan, Portland, OR (US)

(72) Inventor: Sriram Varadhan, Portland, OR (US)

(21) Appl. No.: 15/897,165

(22) Filed: Feb. 15, 2018

(51) Int. Cl. G06F 3/16; G06F 3/0482; G06F 3/0481; G06F 17/30

(52) U.S. Cl. CPC G06F 3/165; G06F 17/30772; G06F 3/04817; G06F 3/0482

(57) ABSTRACT

A method is proposed to eliminate manually ‘skipping’ of the songs manually while driving or engaged in physical activities.

### BACKGROUND

### Field of the Invention

The present invention relates to a mobile app to address the problem of millions of users skipping the songs from smartphones while driving autos or engaged in other physical activities such as sports.

### Description of the Related Art

With the rapidly advancing technology we are in the need of some unique applications that will help us to make our lives easier. The number of mobile Apps available has grown-up massively over the past few years. With the smartphones and Internet have taken up most of our daily lives, very few Apps among millions are really serving our purposes.

Often, songs contain a portion which a user does not desire to listen to repeatedly, even if the user wishes to listen to another portion of the song repeatedly. For instance, a song may have an introduction in which the artist that wrote the song is talking, and the user may not wish to listen to the introduction every time the user listens to the song. However, manually skipping the introduction every time the user listens to the song can be burdensome, and even dangerous if the user is e.g. driving while tying to manipulate their device to skip the portion.

Many people have portable music devices such as an MP3 player, a Microsoft® Zune™ device, or other portable music players, and many of those devices contain hundreds or thousands of songs in their owners' personal music collections. With such large music collections, selecting songs to listen to becomes a challenge. Users want to listen to different songs at different times, but often do not have the time or inclination to repeatedly select songs to play from their personal collection. Also, it is difficult for users to select songs on the move with portable devices, such as when jogging or driving.

Current music players provide a “shuffle” function, which randomly selects songs for playback. This is a basic and simplistic solution that is very limited in its ability to satisfy users' requirements in changing songs. In general, the shuffle function provides users with no real control over what is played.

However, to Applicant's knowledge, there is no solution through a Mobile application available to automatically update registered user's new number directly in all their smartphone contact's phonebook. It is directed to such a system of single Mobile application that provides solution to all the above scenarios that the present invention is directed.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to LetzRock Mobile App Music player basically creates a playlist based on the user's mood and helps its users categorize their music based on their mood. Now with the LetzRock Mobile App Music player, listening to music is seamless and breezy as you now can listen to the music you want to, based on your mood.

Another object of the invention relates to the emoji from the mood menu based on your mood and then the music plays. The moods available are: Happy, Sad, Party, Confused, Romantic, Workout, Poop and Driving. The user need not fret about understanding the app or being able to use it as the interface of the app is very simplified and made easy to understand and use.

Another embodiment of the present invention is a way to build a playlist based on similarity of songs to a set of user provided-attributes, such as corresponding to moods or usage modes such as “resting” “happy” “romantic” or “driving” moods/modes. Those songs which are deemed similar are built into a playlist, whereby a user has a subset of similar songs that are playable without needing to select each of those similar songs to play them. The playlist may be dynamically adjusted based on user interaction, such as when a user skips a song, queues a song, or dequeues a song.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows the song-list the mobile design is not claimed.

FIG. 200 shows the emoji list.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention LetzRock Mobile App Music player basically creates a playlist based on the user's mood and helps its users categorize their music based on their mood. In certain scenarios, our music box, smartphones or mp3 is a sea of music and most of the times we practically end up skipping songs after songs because it doesn't match the mood we are in. With LetzRock Mobile App Music player, listening to music is seamless and breezy as you now can listen to the music you want to, based on your mood.

Another embodiment of the present invention is to select an emoji from the mood menu based on your mood and then the music plays. The moods available are: Happy, Sad, Party, Confused, Romantic, Workout, Poop and Driving. The user need not fret about understanding the app or being able to use it as the interface of the app is very simplified and made easy to understand and use.

Some of the benefits of the LetzRock Mobile App Music Player include:

Easy music selection based on mood.

Arranged playlist.

Customized playlist.

Free music listening.

Easy Navigation.

Saves time as there is no need for continuous skipping.

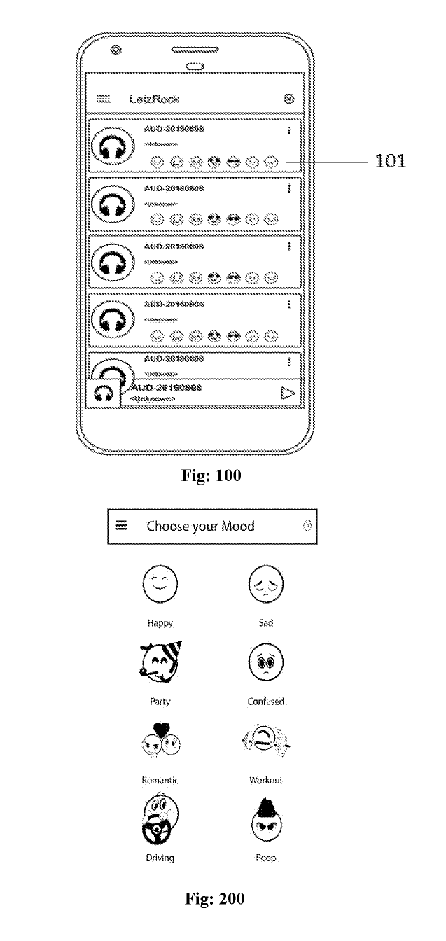

FIG. 100 shows music player when the user selects the Emoji mood 101 under each song, the song will automatically categorized in the main menu as per the selected Mood. Similarly, the user categorizes all the songs by clicking the Emoji moods. The user can also select multiple Emoji moods for the same song. FIG. 200 shows emoji mood such as Happy, Sad, Party, Confused, Romantic, Workout, Poop and Driving.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A music player app to eliminate ‘skipping’ the songs manually comprising:
1) an emoji 101 to select from the mood menu based on user mood. The moods available are Happy, Sad, Party, Confused, Romantic, Workout, Poop and Driving.
2) library menu which contains all the songs and music playlist from your phone memory. From the music library, you can navigate easily from one song to another based on the playlist.
3) The method of claim 2, wherein the songs and music playlist comprises at least one of: audio content, video content, and audio video (AV) content.
